(19) United States
(12) Patent Application Publication
(10) Pub. No.: US 2005/0210161 A1
(43) Pub. Date: Sep. 22, 2005

(54) Computer device with mass storage peripheral (s) which is/are monitored during operation

(76) Inventors: Jean-Pierre Guignard, Toulouse (FR); Sebastien Rabaud, Toulouse (FR); Franck Paulus, Toulouse (FR); Jean-Pierre Adi, Lescure D'Albigeois (FR); Joel Gaboriau, Pibrac (FR); Fernando Moreira, Plaisance Du Touch (FR)

Correspondence Address: YOUNG & THOMPSON, 745 SOUTH 23RD STREET, 2ND FLOOR, ARLINGTON, VA, 22202, US

(21) Appl. No.: 11/080,508

(22) Filed: Mar. 16, 2005

Related U.S. Application Data
(60) Provisional application No. 60/558,148, filed on Apr. 1, 2004.

(30) Foreign Application Priority Data
Mar. 16, 2004 (FR) 04.02704

(51) Int. Cl. G06F 13/10

(52) U.S. Cl. 710/15

(57) ABSTRACT

A computer device (1) includes at least one mass storage peripheral (2) having a read and/or write device (3) which is adapted for receiving a removable storage medium (4). The computer device (1) also includes at least one module (6) for monitoring the quality of operation of at least one mass storage peripheral (2) in service, called a monitored peripheral (2). This monitoring module (6) is adapted for collecting and recording over time the activity data which the monitored peripherals (2) generate, and which represents the use and/or operation of these monitored peripherals (2). The computer device (1) also includes a processing module (7) which is adapted for calculating and recording a history of the quality parameters from collected and recorded activity data, to be able to prevent and/or detect a malfunction of each monitored peripheral (2).

The invention concerns a computer device including at least one mass storage peripheral including at least one read and/or write device which is adapted for receiving at least one removable storage medium. As an example, a mass storage peripheral includes a read and/or write device for magnetic tape, or optical disk, or diskette, etc.

These mass storage peripherals are used, in particular, to carry out backups, to migrate data between machines, or to archive sensitive data. It is therefore important that these mass storage peripherals should function perfectly reliably. In this sense, it would be advantageous to be able to prevent any failure of such a peripheral, to avoid losing any data. Additionally, such a failure must be detected, diagnosed and signaled to the user when it is produced in the course of operation in its normal environment.

Today, no known device makes it possible to solve these problems simultaneously.

For example, diagnostic devices for mass storage peripherals are known. To use these diagnostic devices, it is necessary to disconnect the mass storage peripheral from its normal operating environment, and to associate it with the diagnostic device, which carries out a full diagnosis of the various mechanisms and internal components of the peripheral. Nevertheless, such a diagnostic device does not make it possible to monitor the peripheral during operation, and makes it necessary to use a reference read and/or write device or a reference removable storage to distinguish the origin of a failure.

Additionally, in modern computer devices, software for managing backups and archiving is sometimes provided, which only issues alarm messages when a crippling failure occurs during reading and/or writing, and/or when the number of use cycles of a removable storage medium is exceeded.

In the same way, on modern computer devices, modules for monitoring the general operation of the computer device are often provided. These are responsible for centralizing the various state information of the constituent components of the device and any error information or alarm messages which the various components supply to the central processing unit (CPU). Nevertheless, these modules are not adapted for managing specifically the mass storage peripherals, or for monitoring the quality of data which can be recorded on these peripherals. They also do not make it possible to distinguish the origin of any failure, as to whether it comes from the read and/or write device or from the removable storage medium, or even to prevent a failure on a mass storage peripheral.

The invention thus aims at solving this general problem. It aims at proposing a computer device in which preventive monitoring of at least one mass storage peripheral in service is carried out.

The invention aims more particularly at proposing a computer device which makes it possible to prevent and/or detect any malfunction of a mass storage peripheral, and to determine whether the origin of such a risk of malfunction or such a malfunction is the removable storage medium and/or the read and/or write device.

More generally, the invention aims at proposing a computer device which provides the user with an in-depth analysis of the quality of operation of the various mass storage peripherals, without making it necessary to disconnect these mass storage peripherals or to put them out of operation, or interfering with the normal operation of this computer system, and in particular with the various software which makes use of these mass storage peripherals.

The invention also aims at proposing such a computer device which is simple, ergonomic, and inexpensive to install and to use.

To do this, the invention concerns a computer device comprising:
at least one mass storage peripheral comprising at least one read and/or write device, and adapted for receiving at least one removable storage device, this mass storage peripheral being adapted for generating data, called activity data, which represents its use and/or operation,
at least one software application which is adapted to carry out read and/or write operations with the mass storage peripheral(s) in service,
at least one module for monitoring the quality of operation of at least one mass storage peripheral in service, called a monitored peripheral, this monitoring module being adapted for:
   detecting, for each monitored peripheral, whether at least one read and/or write device of a monitored peripheral receives a removable storage medium, this monitored peripheral being called an active monitored peripheral, or on the other hand whether it receives no removable storage medium, the monitored peripheral being called an inactive monitored peripheral,
   collecting and recording over time, for each active monitored peripheral, the activity data, called monitoring data, comprising data called read and/or write quality data, which is adapted for making it possible to calculate the quality parameters, the development of which over time is representative of a drift of the quality of read and/or write operations by each monitored peripheral,
at least one processing module which is adapted for calculating and recording, on the basis of the monitoring data, a history of the quality parameters, called the activity history, of each read and/or write device of a monitored peripheral, this activity history being adapted for making it possible to prevent and/or detect a malfunction of each monitored peripheral.

A computer device according to the invention can consist of one or more machine(s). For example, these may be a single computer with its CPU including at least one processor, and its peripherals which are connected to this CPU via a peripheral bus. They may equally well be multiple computers which are connected in a network, or any other computer architecture which is equipped with means of communication, whether remote or not, between multiple machines and/or parts of machines.

Advantageously and according to the invention, the device includes multiple mass storage peripherals, and the monitoring module is adapted for being able to collect and record monitoring data from multiple monitored peripherals.

Advantageously and according to the invention, the activity history includes at least one quality parameter which is chosen from the read error rate and/or write error rate.

Advantageously and according to the invention, the monitoring module is adapted for being able to read, in at least one storage of the computer device, at least one item of identification data for each removable storage medium, called an identified removable medium, which is received in each monitored peripheral. Additionally, the processing module is adapted for calculating and recording a history of the quality parameters, called the activity history, of each identified removable storage medium, making it possible, with the activity history of each read and/or write device, to determine whether the origin of this malfunction is the removable storage medium (4) and/or the read and/or write device.

Additionally, advantageously and according to the invention, the activity history of each identified removable storage medium includes at least one quality parameter which is chosen from the read error rate and/or write error rate, and/or the number of loading and/or unloading operations, and/or the duration of use in a read and/or write device.

Additionally, advantageously and according to the invention, the processing module is adapted for updating a single centralized database including the quality parameters of each read and/or write device of a monitored peripheral, and the quality parameters of each identified removable storage medium. This database forms the activity histories of each read and/or write device and each identified removable storage medium. Thus the recorded activity histories in the form of a database make it possible to do sorts, selections, and miscellaneous analyses, making it possible to carry out a highly reliable preventive diagnosis of each read and/or write device and each used removable storage medium.

Advantageously and according to the invention, the device additionally includes at least one diagnostic module which is adapted for, from each activity history which it receives, triggering an alarm event when at least one quality parameter takes a value corresponding to a risk of possible malfunction of the removable storage medium and/or of a read and/or write device.

Advantageously and according to the invention, the processing module is adapted for calculating a value of at least one development parameter which represents the variation over time of a quality parameter. Additionally, the diagnostic module is adapted for triggering an event alarm when at least one development parameter takes a value corresponding to a risk of possible malfunction of the identified removable storage medium and/or of a read and/or write device. A device according to the invention thus makes it possible, from the activity histories, to anticipate the possible failures of any monitored mass storage peripheral, and to determine the possible origin of such a failure or risk of failure (read and/or write device or removable storage medium).

The device according to the invention thus makes it possible to monitor every active mass storage peripheral in service, and to trigger an alarm even before a failure occurs. All loss of data is thus avoided.

Advantageously and according to the invention, the processing module is adapted for comparing each development parameter with a predetermined threshold value, and the diagnostic module is adapted for triggering an alarm event when this threshold value is exceeded.

Additionally, advantageously and according to the invention, the diagnostic module is adapted for comparing each quality parameter with a predetermined threshold value, and triggering an alarm event when this threshold value is exceeded.

The diagnostic module advantageously supplies to the user information corresponding to alarm events, in particular in the form of an alarm message or an action message to be carried out.

Advantageously and according to the invention, an alarm event includes a message indicating at least one loading and/or unloading event to be carried out. In fact, after detecting a probable malfunction, the diagnostic module can indicate that the operator should either place a removable storage medium in the read and/or write device, or place the previously used removable storage medium in a different read and/or write device which is assumed to function properly. This simple operation and the subsequent resulting analysis by means of the monitoring module, processing module and diagnostic module will make it possible to distinguish, with certainty, the origin of the probable malfunction which was detected previously. It should also be noted that the loading and/or unloading operation may make it possible to avoid the appearance of a crippling operational breakdown of the relevant mass storage peripheral. Any loss of data is thus avoided.

The monitoring module of a device according to the invention is advantageously adapted for collecting monitoring data periodically, according to a predetermined period.

Advantageously and according to the invention, this period is between 1 s and 10 min, particularly of the order of 1 min.

Nevertheless, as a variant, nothing prevents providing that the monitoring module should itself be controlled by another application, e.g. an application for managing a set of mass storage peripherals. Also, nothing prevents providing that the monitoring period should be adjustable either manually or automatically according to other parameters, e.g. the rate of operation or the load on the set of mass storage peripherals.

Additionally, advantageously and according to the invention, the monitoring module is adapted for being able to transmit the monitoring data to the processing module, and the processing module is adapted for calculating and recording each activity history immediately after receiving this monitoring data.

Additionally, advantageously and according to the invention, the diagnostic module is adapted for being executed immediately after each recording of an activity history by the processing module.

Advantageously and according to the invention, each mass storage peripheral includes a local store, called an activity register, and at least one controller which is adapted for being able to record the activity data in those areas of the activity register which are predetermined according to the nature of the activity data, and the monitoring module is adapted for reading those areas of the activity register which correspond to monitoring data.

The invention thus makes it possible to constantly detect and record the operational state of the various monitored mass storage peripherals and, from the activity history, to prevent the malfunctions, to detect them if necessary, and above all to know precisely the origin of malfunctions.

The invention also concerns a method of monitoring mass storage peripherals, implemented in a computer device according to the invention.

In a monitoring method according to the invention, monitoring data is collected and recorded, and from this monitoring data an activity history of each identified removable storage medium and of each read and/or write device of each monitored peripheral is formed.

The invention also concerns a device and a method which in combination have all or some of the features mentioned above or below.

Other features, aims and advantages of the invention will appear when reading the following description, which refers to the attached figures, in which:

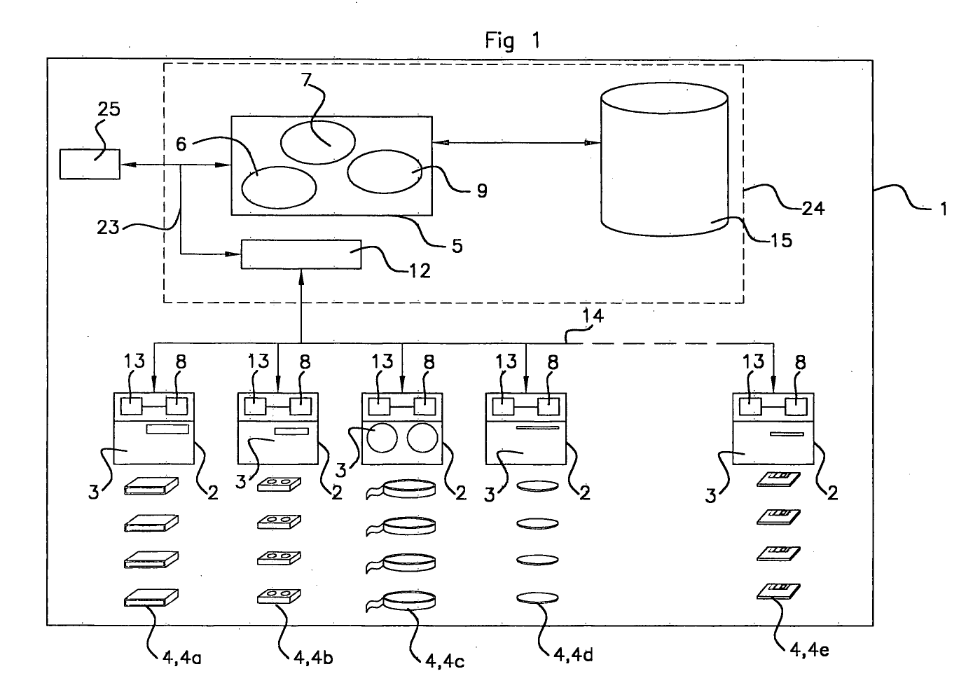

FIG. 1 is a diagram showing a first implementation variant of a computer device according to the invention,

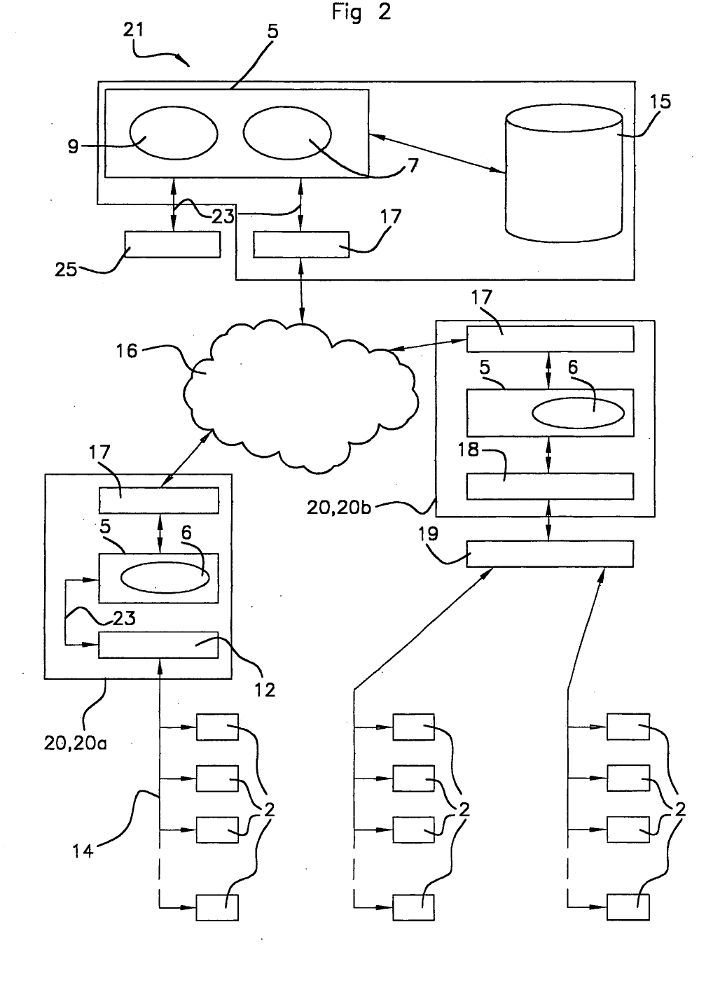

FIG. 2 is a diagram showing a second implementation variant of a computer device according to the invention,

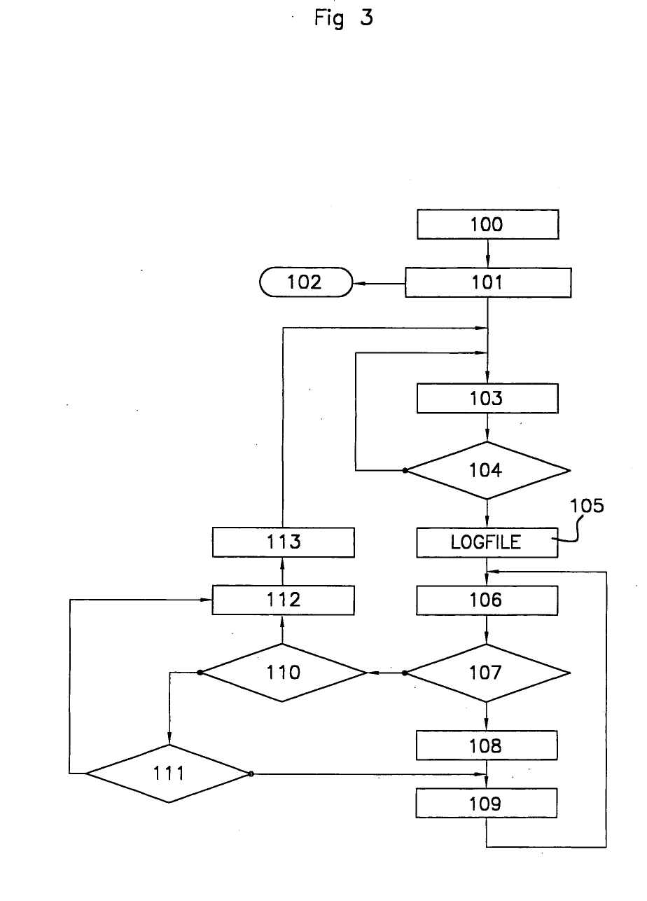

FIG. 3 shows an example of an algorithm of a monitoring module according to the invention,

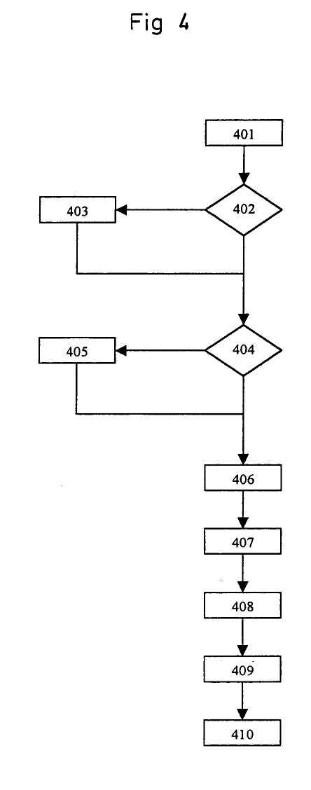

FIG. 4 shows an example of an algorithm of a processing module according to the invention,

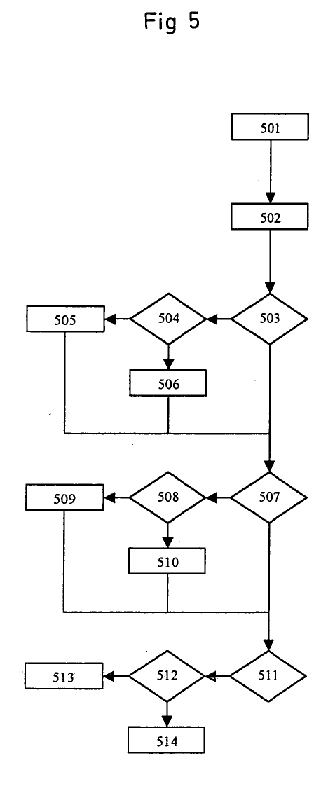

FIG. 5 shows an example of an algorithm of a diagnostic module according to the invention,

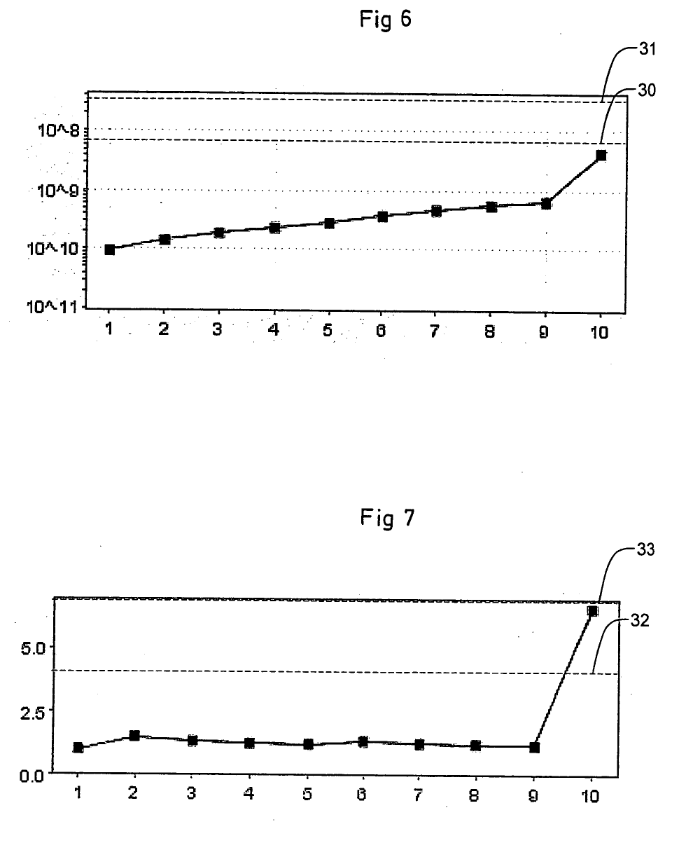

FIG. 6 shows a graphic illustrating the development over time of a quality parameter according to the invention, i.e. a recording error rate τe which is attributable to a removable storage medium,

FIG. 7 shows a graphic illustrating the development over time of a development parameter according to the invention, i.e. a variation Ve over time of the error rate τe of FIG. 6.

The computer device 1 (shown in FIG. 1) includes multiple mass storage peripherals 2, each of these mass storage peripherals 2 including at least one read and/or write device 3 which is adapted for being able to receive a removable storage medium 4 simultaneously.

For example, the removable storage media 4 can be of the type of magnetic tapes in cassettes 4a, 4b or on spools 4c, or of the type of optical discs 4d (CD-ROM, DVD, etc.), or of the type of diskettes 4e or electronic smart card (not shown), or other. Each of these removable storage media 4 includes an identifier, this identifier being either recorded at formatting and/or first writing to the removable storage medium 4, so that it can be read by the read and/-or write device 3, or written in the form of a code on the medium 4 and able to be entered and/or read at loading so that it can be communicated automatically to the computer device 1, or assigned by the computer device 1 according to the position in which the medium 4 is inserted.

Each mass storage peripheral 2 is connected to a peripheral bus 14 of the computer device 1. The computer device can include multiple peripheral buses 14, each of which can be connected to multiple mass storage peripherals 2.

Each mass storage peripheral 2 is adapted for generating data, called activity data, which represents its use and/or operation. For each type of mass storage peripheral 2, at least part of the activity data is defined and standardized. In particular, the activity data in the definition standard of the bus 14 of the associated peripheral is concerned. For example, the SCSI standard defines some activity data.

Each storage peripheral 2 preferably includes a local storage, called the activity register 8, for each read and/or write device 3 of this mass storage peripheral 2. The activity data is generated and recorded in this activity register 8, in particular data representing the operation and/or use of this read and/or write device 3 with at least one removable storage medium 4. The mass storage peripheral 2 also includes at least one controller 13, which is associated with the activity register(s) 8 to allow the generation and recording of activity data in this/these activity register(s) 8.

The activity data is recorded by means of the controller(s) 13 in different storage areas of each activity register 8 according to the nature of the activity data. Thus reading each storage area, which is specific to each category of activity data, makes it possible to recover the activity data knowing its exact nature.

Nothing prevents a mass storage peripheral 2 including only one activity register 8 for multiple read and/or write devices 3, provided that means of recovering the activity data are provided, making it possible to identify the read and/or write device 3 from which each of the activity data is output.

Preferably, according to the first embodiment of the invention, each mass storage peripheral 2 includes only one read and/or write device 3, only one activity register 8 and only one controller 13 which is associated with this activity register 8.

The controller 13 of each storage peripheral 2 is adapted for being able to receive commands to read these storage areas via the peripheral bus 14 to which it is connected. The controller 13 of the mass storage peripheral 2 is also adapted for supplying the requested activity data on this peripheral bus 14. For example, each mass storage peripheral 2 can be a mass storage peripheral 2 which conforms to the SCSI standard. This SCSI standard actually provides for an architecture and a set of commands which enable access to activity data of the mass storage peripherals 3 via an SCSI peripheral bus 14 to which they are linked.

The invention is also applicable to other types of bus 14, for example according to the ATA, SATA, FC (“Fiber Channel”), ESCON or FICON or other standards. The invention is applicable to storage peripherals 2 which are connected to peripheral buses 14, provided that this read and/or write quality data, as described above, is generated by these peripherals 2, and that the data is accessible via this bus 14.

The computer device 1 according to the invention includes at least one monitoring module 6 which is adapted for being able to initiate commands to read activity data on at least one peripheral bus 14 to at least one mass storage peripheral 2 in service, called a monitored peripheral 2, and to read the data via this peripheral bus 14 to record the data in a storage.

According to the first embodiment, the computer device 1 (see FIG. 1) also includes, in the traditional way, at least one CPU 5 which is equipped with at least one processor, at least one RAM and at least one input-output controller (not shown). The CPU 5 also includes an internal bus (not shown) which connects the processor to the RAM and the input-output controller. The peripheral bus 14 is a bus of SCSI type, for example, and is connected to an SCSI controller 12. The SCSI controller 12 is itself connected to the input-output controller via an input-output bus 23, in such a way that it can be commanded by the CPU 5 via SCSI bus driver software, which is loaded into the RAM of the CPU 5. The computer device 1 also has, in the traditional way, an operating system such as WINDOWS®, UNIX®, LINUX. The SCSI bus driver software is linked to the operating system, and is started up simultaneously with the latter when the computer device 1 starts.

In the first embodiment, the computer device 1 includes a single computer 24 (shown by a dotted line). Each mass storage peripheral 2 is powered and connected to the bus 14 so that it is visible by the computer 24. The computer 24 includes the CPU 5 in particular, as well as the traditional components of such a computer such as a non-removable mass storage (not shown), e.g. a hard disk, a human/machine interface 25 (keyboard, pointer, screen, etc.) and the associated peripheral cards (not shown) which are connected to the input-output bus 23 via the traditional buses and controllers which are used. Since the peripheral bus 14 is connected to this computer 24 via the SCSI controller 12, this single computer 24 controls all the mass storage peripherals 2 which are associated with this bus 14. Additionally, this single computer includes a software application (not shown) which is loaded into RAM and implements traditional read and/or write operations with these mass storage peripherals 2 in service.

The computer device 1 includes at least one monitoring module 6, at least one processing module 7 and at least one diagnostic module. According to the first embodiment, the computer device 1 includes a single monitoring module 6. This monitoring module 6 can be a computer program which is loaded into the RAM of the CPU 5. This monitoring module 6 can also, via the SCSI bus driver software, initiate commands to the monitored peripherals 2 to determine whether this is loaded with a removable storage medium 4, this storage peripheral 2 is then said to be active. This can be implemented using the SCSI command “TEST UNIT READY”, for example. In the negative case, this peripheral 2 is said to be inactive. Similarly, the monitoring module can initiate read commands to the active peripherals 2 to collect activity data from these active peripherals 2. This can be implemented using the SCSI command “LOG SENSE”, for example.

This collected and recorded activity data, called monitoring data, includes read and/or write quality data from which it is possible to calculate and/or obtain quality parameters such as are described below. This read and/or write quality data includes, for example:
the total duration of use (activation) of an internal mechanism of the read and/or write device 3 of the monitored peripheral, making it possible to drive the removable storage medium for reading and/or writing,
the total duration to power up the monitored peripheral 2,
the number of uncorrected read and/or write errors since the last acquisition of activity data,
the number of corrected read and/or write errors since the last acquisition of activity data,
the number of bytes written and/or read since the last acquisition of activity data.

Additionally, the monitoring data preferably includes identification data of the removable storage medium 4 which is loaded on an active peripheral 2, and identification data of the read and/or write device 3 on which this removable storage medium 4 is loaded. In the case that the active peripheral 2 includes only one read and/or write device 3, the identifier of this read and/or write device 3 corresponds to the identifier of the said active peripheral 2.

In practice, the monitoring data generally includes data which makes it possible to identify the monitored peripherals 2 and the read and/or write devices 3 of these monitored peripherals 2. However, it frequently happens that the monitored peripheral 2 does not produce activity data which makes it possible to identify the storage medium 4 which is loaded on this storage peripheral 2. This information can then be obtained otherwise than by interrogation of the register(s) 8 of the storage peripheral. This information can be supplied by the user by means of the human/machine interface 25, for example.

In one implementation variant, the monitoring module 6 identifies a storage medium 4 which is loaded into an active peripheral 2 by interrogating a storage of a roboticized arm (not shown) which carries out loading and unloading operations on the removable storage media 4 in the mass storage peripherals 2, of which it has recorded a physical position and an identifier. Such a roboticized arm generally includes a code reader for optoelectronic reading, e.g. of bar codes, making it possible to enter codes which are placed on each removable storage medium 4. The entered codes make it possible to identify, in the storage of the roboticized arm, each storage medium 4 which is loaded into a read and/or write device 3. The roboticized arm preferably includes an interface which makes it possible to connect it to a peripheral bus 14 of the computer device 1. The monitoring module 6 can thus interrogate the storage of the roboticized arm to obtain the identifier of a removable storage medium 4 which is loaded in a peripheral 2 which is identified by the monitoring module 6.

Additionally, the monitoring data can include data, called alarm data, signaling a malfunction of the active peripheral 2. For example, this data is the TAPE_ALERT data which the SCSI standard provides for certain types of peripherals. In the case that the storage peripheral 2 is a peripheral of SCSI type, the alarm data signals, in particular:
an abnormal internal temperature,
an abnormal internal humidity,
a tape break (in the case that the storage medium 4 is of a magnetic tape type),
etc.

The monitoring module 6 can implement these collection and recording operations for each read and/or write device 3 of a monitored peripheral 2, according to the algorithm shown in FIG. 3. In this example, the computer device includes a roboticized arm which is connected to a peripheral bus 14 so that it can load and unload the removable storage media 4 and identify every removable storage medium 4 which is loaded in each active peripheral 2 as described above. This roboticized arm can be, for example, of the type which is included in a magnetic tape library (Autoloader) such as those which are marketed by companies such as STORAGETEK (LOUISVILLE, Colo., USA), QUANTUM ATL (SAN JOSE, Calif., USA), OVERLAND (SAN DIEGO, Calif., USA).

Stage 100 consists firstly of initiating read commands to the monitored peripheral 2, to obtain identification data from this mass storage peripheral 2:
the serial number of the mass storage peripheral 2,
the identity of the manufacturer of the mass storage peripheral 2, called VENDORID,
the model of the mass storage peripheral 2, called PRODUCTID.

The subsequent stage 101 consists of comparing (by means of the VENDORID and PRODUCTID data) the model identifier obtained with a list, with which the monitoring module 6 is equipped, of supported mass storage peripheral models 2. If the mass storage peripheral model 2 is supported, stage 103 is executed, otherwise the final stage 102 is executed.

Stage 103 consists of waiting for a given period, called the loading period of the removable storage medium 4. This period is preferably fixed by the user.

The subsequent stage 104 consists of detecting whether the monitored peripheral 2 is active, i.e. whether the read and/or write device is loaded with a removable storage medium 4.

If the monitored peripheral 2 is inactive, i.e. if the read and/or write device is not loaded with a removable storage medium 4, control returns to the previous waiting stage 103. If a storage medium 4 is detected in the monitored peripheral, stage 105 is executed.

The subsequent stage 105 consists of creating a file, called LOGFILE, to record monitoring data of the active monitored peripheral 2. Stage 105 also consists of recording, in the LOGFILE file, the identification data of stage 100, and of initiating a command to the roboticized arm making it possible to identify the removable storage medium 4 which is loaded in the active peripheral 2. The identifier of this storage medium 4 is then recorded in the LOGFILE file.

The subsequent stage 106 consists of executing commands to read the storage areas of the activity register 8 of the active monitored peripheral 2, to collect the following monitoring data:
the total number of corrected write errors since the last collection of monitoring data, called COR_WRITE,
the total number of uncorrected write errors since the last collection of monitoring data, called UNCOR_WRIT,
the total number of bytes written since the last collection of monitoring data, called BYTES_WRITTEN,
the total number of corrected read errors since the last collection of monitoring data, called CORRE_READ,
the total number of uncorrected read errors since the last collection of monitoring data, called UNCOR_READ,
the total number of bytes read since the last collection of monitoring data, called BYTES_READ,
TAPE_ALERTs (SCSI standard for tape reader) at the instant of the present collection of monitoring data, called TAPE_ALERT_FLAGS.

If no error is detected by the subsequent test 107 at the time of the command to read these storage areas, stage 108 records the monitoring data which was read at the time of stage 106 in the LOGFILE file. When this monitoring data is recorded in the LOGFILE file, it is associated with a collection number, called LINE, and the date and time of this collection, called DATE. These values LINE and DATE are generated by the monitoring module 6.

The subsequent stage 109 consists of waiting for a given period, called the collection period, at the end of which the read stage 106 and the subsequent stages for a new collection of monitoring data are repeated. The collection period is preferably fixed by the user.

If an error is detected by test 107 when the storage areas of the activity register 8 are read, test 110 is executed. This test makes it possible to determine whether this error is an error of the absence of the removable storage medium 4 in the mass storage peripheral 2. Such an error indicates that the removable mass storage medium 4 has been unloaded. If this is the case, the LOGFILE file is closed in stage 112.

Stage 112 also consists of collecting and recording, in the LOGFILE files, before this file is closed, the following read and/or write quality data:
the total duration to power up the mass storage peripheral 2, called POWER_ON_HOURS,
the total duration of use (activation) of the internal mechanism of the read and/or write device 3 of the mass storage peripheral 2, called TAPE_MOTION_HOURS.

The LOGFILE file is then communicated to the processing module 7 in the subsequent stage 113. The monitoring module 6 then repeats stage 103 and the subsequent stages, to create a new LOGFILE representing a use cycle of a storage medium 4 on the monitored peripheral 2.

If an error is detected when the storage areas of the activity register are read in stage 107, and this error is not an error of the absence of the mass storage medium 4 as determined by test 110, test 111, which consists of determining whether or not a maximum threshold value of the number of acceptable read errors of the storage areas of register 8 is exceeded, is executed.

In the negative case, control passes to stage 112. In the positive case, stage 109 is executed.

According to the first embodiment of the invention, the processing module 7 is a program which is loaded into the RAM of the single computer 24. The processing module 7 is adapted for keeping up to date, from the LOGFILE files which the monitoring module 6 creates, an activity history for each identified storage medium 4 and an activity history for each read and/or write device 3 of a monitored peripheral 2. Each of these activity histories can be implemented by a table of a database 15 of the single computer 24. This database 15 can be recorded on the hard disk of the single computer 24. Additionally, this database 15 can be managed by means of database management software such as MYSQL®, ORACLE® or other.

Alternatively, the processing module can be adapted for recording the quality parameters, calculated from the LOGFILE files as described below, in a record file (not shown) which is recorded on the hard disk of the single computer 24, and for recording, with each of these quality parameters, an identifier of an identified storage medium 4 and/or an identifier of a read and/or write device 3 referring to the quality parameter. As an example, in such a record file:
quality parameters, each representing the total number of use cycles of a removable storage medium 4, would each be recorded with an identifier of the said removable storage medium 4,
write error rates, each obtained during one use cycle of a removable storage medium on a read and/or write device 3, would each be recorded with an identifier of the said removable storage medium 4 and an identifier of the said read and/or write device 3,
quality indices, each representing the quality of write operation of a read and/or write device 3 relative to other read and/or write devices, would each be recorded with an identifier of the said read and/or write device 3.

Additionally, such a processing module can be adapted to date each quality parameter record in the record file. Thus, in such a record file, the quality parameter records which are associated with the identifier of a removable storage medium 4 form an activity history of this removable storage medium. Additionally, the quality parameter records which are associated with the identifier of a read and/or write device 3 form an activity history of this read and/or write device 3. Thus the record file can be processed by means of an analysis module to make it possible to prevent and/or detect a malfunction of each monitored peripheral 2, and to determine whether the origin of this malfunction is the removable storage medium and/or the read and/or write device 3.

Preferably, the processing module 7 updates the activity history of a removable storage medium 4 and the activity history of a read and/or write device 3 following a use cycle, beginning with loading and ending with unloading this removable storage medium 4 on this read and/or write device 3, i.e. when the monitoring module 6 supplies the LOGFILE file from this use cycle to the processing module 7.

The processing module 7 also makes it possible to calculate, from each LOGFILE file which the monitoring module 6 produces, quality parameters from read and/or write quality data of the LOGFILE file. These quality parameters are calculated for each LOGFILE file and recorded in the activity history of the storage medium 4 which the LOGFILE file identifies and in the activity history of the read and/or write device 3, to be able to detect any drift of these quality parameters over time.

The quality parameters are, for example:
the total duration to power up the monitored peripheral 2 associated with a read and/or write device 3,
the total duration of use (activation) of a removable storage medium 4 by the internal mechanisms of the monitored peripherals 2,
the total number of use cycles of the removable storage medium 4 carried out on a read and/or write device 3,
the total number of use cycles of a removable storage medium 4,
the write error rate Te which is obtained during one use cycle of a removable storage medium on a read and/or write device 3,
the read error rate Tl which is obtained during one use cycle of a removable storage medium 4 on a read and/or write device 3,
a quality index Qe representing the write operation quality of a read and/or write device 3 relative to other read and/or write devices 3 of monitored peripherals 2,
a quality index Ql representing the quality of a read and/or write device 3 relative to the other read and/or write devices 3 of monitored peripherals 2,
the write error rate τe which is attributable to the removable storage medium 4 during one use cycle,
the read error rate τl which is attributable to the removable storage medium 4 during one use cycle.

The processing module 7 is also adapted for being able to calculate development parameters, representing the variation over time of a quality parameter, from the activity histories.

These quality parameters are, for example:
the variation Ve of the write error rate τe between two use cycles of a removable storage medium 4,
the variation Vl of the write error rate τl between two use cycles of a removable storage medium 4.

The values of the error rates Te, Tl, τe and τl, the variations Ve and Vl and the quality indices Qe and Ql are preferably calculated by the processing module 7 for each LOGFILE file. After it is calculated, this data is recorded in the activity histories of the removable storage medium 4 and the corresponding read and/or write device 3.

For example, the processing module 7 can calculate the write error rate Te using the read and/or write quality data:

$$Te = \frac{{\sum }_{LINE = 1}^{NB\_LINE} COR\_WRITE ( LINE )}{{\sum }_{LINE = 1}^{NB\_LINE} BYTES\_WRITTEN ( LINE )}$$

where the term NB_LINE corresponds to the total number of collections carried out for the use cycle corresponding to the LOGFILE file.

Additionally, the processing module 7 can be adapted to calculate the read error rate Tl using the read and/or write quality data:

$$Tℓ = \frac{{\sum }_{LINE = 1}^{NB\_LINE} CORRE\_READ ( LINE )}{{\sum }_{LINE = 1}^{NB\_LINE} BYTES\_READ ( LINE )}$$

The activity history of each removable storage medium 4 preferably includes one record for each use cycle of this medium 4 by a read and/or write device 3. Also, each record of an activity history of a removable storage medium 4 preferably includes:
the TAPE-ALERT-FLAG data corresponding to this use cycle,
the date corresponding to this use cycle of the removable storage medium 4,
the total number of use cycles of this removable storage medium 4 carried out on the date corresponding to one use cycle,
the identifier of the read and/or write device 3 corresponding to this use cycle,
the total number of bytes read during this use cycle,
the total duration of activation of the tape of the removable storage medium 4 by the internal mechanism of the read and/or write device 3 on the date corresponding to this use cycle (for the removable storage medium 4 with magnetic tape),
the read error rate Tl for this use cycle,
the write error rate Te for this use cycle,
the error rate τe for this use cycle,
the error rate τl for this use cycle,
the variation Vl for this use cycle,
the variation Ve for this use cycle.

The total number of use cycles of a removable storage medium 4 can be obtained by incrementing its recorded value in the activity history for the previous use cycle, this number corresponding to the number of unloading operations of this medium 4.

Additionally, the total duration of activation of the tape of the removable storage medium 4 can be easily obtained from the TAPE_MOTION_HOURS data of the LOGFILE file, the activity history of this removable storage medium 4 and the activity history of the read and/or write device 3 which the LOGFILE file identifies.

The activity history of each read and/or write device 3 preferably includes one record for each use cycle of a removable storage medium 4 on this read and/or write device 3. Also, each record of an activity history of a read and/or write device 3 preferably includes:
the date corresponding to this use cycle of a removable storage medium 4 on this read and/or write device 3,
the total number of use cycles which have been carried out on this read and/or write device 3 on the date corresponding to this use cycle,
the identifier of the storage medium 4 which is used on this read and/or write device for this use cycle,
the total number of bytes read by the read and/or write device 3 during the use cycle,
the total number of bytes-written by the read and/or write device 3 during the use cycle,
the total duration to power up the read and/or write device 3 on the date corresponding to this use cycle,
the total duration of use (activation) of the internal mechanism of the read and/or write device 3,
the read error rate Tl for this use cycle,
the write error rate Te for this use cycle,
the quality index Qe for this use cycle,
the quality index Ql for this use cycle.

The total number of use cycles of removable storage media 4 on a read and/or write device 3 can be obtained by incrementing its recorded value in the activity history for the previous use cycle.

The quality index Qe of each read and/or write device 3 can be obtained by comparing the values of the error rate Te obtained during the use cycles of multiple removable storage media 4 on this read and/or write device 3 with the error rates Te obtained with the same removable storage media 4 on other read and/or write devices of the computer device. Multiple statistical operators such as the mean, standard deviation and others actually make it possible to carry out such a comparative analysis of the write operational quality of the read and/or write devices 3 of the monitored peripherals 2.

For example, the processing module 7 is preferably adapted for being able to calculate, from the activity histories of each read and/or write device 3, the mean \overline{T}e of the write error rates Te which are obtained by the read and/or write devices 3 of the computer device 1 during the use cycles of the removable storage media 4 on the read and/or write devices 3. A quality index Qe is assigned for each read and/or write device 3 by comparison of the mean of the error rates Te which this read and/or write device 3 obtains with the global mean \overline{T}e. For example, the higher the mean of the error rates Te of the read and/or write device 3 is relative to the value \overline{T}e, the higher the value of the quality index Qe is.

The processing module 7 can obtain the quality index Ql, using the calculated error rates Tl, in a similar way to the quality index Qe.

Data other than Te and Tl, in particular monitoring data, quality parameters and development parameters, could be used to calculate the quality indices Qe and Ql.

Additionally, the error rate Tl can be obtained according to the following equation:
τl=Tl×Ql

Similarly, the error rate τe can be obtained according to the following equation:
τe=Te×Qe

Additionally, the variation Ve can be obtained according to the following equation:

$$Ve = \frac{τ e}{τ {e}^{′}}$$

where τe′ corresponds to the rate τe which was calculated for this removable storage medium 4 during the previous use cycle of this medium 4.

The variation Vl can be obtained similarly to the variation Ve.

The processing module 7 is adapted for creating and updating the activity history according to the algorithm shown in FIG. 4, each time a LOGFILE file is received.

Stage 401 consists of reading the identification data of the LOGFILE file to identify the read and/or write device 3 and the removable storage medium 4 which has been loaded into this read and/or write device 3.

If the database 15, interrogated by the processing module 7 during test 402, does not include an activity history table corresponding to the read and/or write device 3, at stage 403 a table is created in the database 15 for this read and/or write device 3. Test stage 404 is then executed.

If the database 15, interrogated by the processing module 7 during test 404, does not include an activity history table corresponding to the removable storage medium 4, at stage 405 a table is created in the database 15 for the removable storage medium 4. Stage 406 is then executed.

Stage 406 consists of calculating the quality parameters, particularly Te and Tl, from the monitoring data of the LOGFILE file.

The subsequent stage 407 consists of recording the monitoring data of the LOGFILE file and the quality parameters, particularly Te and Tl, which were calculated in stage 406, in the history table of the read and/or write device 3 according to the date indicated by the LOGFILE file.

The subsequent stage 408 consists of recording the quality parameters, particularly Te and Tl, which were calculated in stage 406, in the history table of the removable storage medium 4 according to the date indicated by the LOGFILE file.

The subsequent stage 409 consists of calculating a new value for Qe, Ql, Ve, Vl, τe and τl, from the activity history tables of the read and/or write device 3 and removable storage medium 4.

The subsequent stage 410 consists of recording the values of Qe and Ql which were calculated in stage 409 in the activity history table of the read and/or write device 3, and recording the values Ve, Vl, τe and τl which were calculated in stage 409 in the activity history table of the removable storage medium 4.

According to the first embodiment, the computer device 1 includes a diagnostic module 9. This diagnostic module can be a program which is loaded into the RAM of the single computer 24 in such a way that it can have access to the database 15 and those tables of this database 15 which form the activity histories of the removable storage media 4 and the read and/or write devices 3 of the computer device 1. The diagnostic module is adapted for being able to detect a malfunction or risk of malfunction of a removable storage medium 4 or a read and/or write device 3. Additionally, the diagnostic module 9 generates alarm events (described below) for each detected malfunction or risk of malfunction.

The diagnostic module 9 preferably executes the algorithm shown in FIG. 5 for each LOGFILE file which the monitoring module 6 creates, and after the processing module 7 has processed this LOGFILE file.

This algorithm makes it possible to implement a diagnosis of the removable storage medium 4 and the read and/or write device 3 which are identified in the LOGFILE file, from their respective activity histories which are recorded in the database 15 by the processing module 7.

Stage 501 consists of:
determining, for each monitoring data item TAPE_ALERT_FLAG of the activity history of the read and/or write device 3, whether one of these monitoring data items takes a predetermined value which indicates a malfunction,
generating an alarm event corresponding to each indicated malfunction.

The subsequent stage 502 consists of:
determining, for each quality parameter of the activity histories of the read and/or write device 3 and removable storage medium 4, whether the quality parameter exceeds a warning threshold value which is fixed for this quality parameter, this threshold value being representative of a risk, which is associated with this quality parameter, of malfunction of the removable storage medium 4 or read and/or write device,
generating an alarm event for each detected risk of malfunction.

The subsequent stage 503 consists of determining whether one of the quality indices Ql or Qe of the activity history of the read and/or write device exceeds a warning threshold value which is fixed for these quality indices, this threshold value being representative of a risk of malfunction of the read and/or write device 3.

If the warning threshold value of stage 503 is exceeded, test stage 504 is executed. This stage 504 consists of determining whether one of the quality indices Ql or Qe exceeds an alarm threshold value which is fixed for these quality indices, this threshold value being representative of a malfunction of the read and/or write device 3.

In the positive case, an alarm event corresponding to the thus detected malfunction is generated in stage 505. In the negative case, an alarm event corresponding to the risk of malfunction which was detected in stage 503 is generated in stage 506.

Test stage 507 is executed after stage 505 or stage 506 is executed.

If it is determined in stage 503 that neither of the quality indices Ql or Qe exceeds the warning threshold value, test stage 507 is executed.

Test stage 507 consists of determining whether one of the error rates τl or τe of the activity history of the removable storage medium 4 exceeds a warning threshold value 30 which is fixed for these read errors, this threshold value being representative of a risk of malfunction of this removable storage medium 4.

If the warning threshold value 30 of stage 507 is exceeded, test stage 508 is executed. Stage 508 consists of determining whether one of the error rates τl or τe exceeds an alarm threshold value 31 which is fixed for these error rates, this threshold value being representative of a malfunction of the removable storage medium 4. In the positive case, an alarm event corresponding to the thus detected malfunction is generated in stage 509. In the negative case, an alarm event corresponding to the risk of malfunction which was detected in stage 507 is generated in stage 510.

Test stage 511 is executed after stage 509 or stage 510 is executed.

If it is determined in stage 507 that neither of the error rates τl or τe exceeds the warning threshold 30 of stage 507, stage 511 is executed.

Test stage 511 consists of determining whether one of the variations Vl or Ve of the activity history of the removable storage medium 4 exceeds a warning threshold value 32 which is fixed for these variations, this threshold value being representative of a risk of malfunction of this removable storage medium 4.

If the warning threshold value 32 of stage 511 is exceeded, test stage 512 is executed.

This stage 512 consists of determining whether one of the variations Vl or Ve exceeds an alarm threshold value 33 which is fixed for these variations, this threshold value being representative of a malfunction of the removable storage medium 4. In the positive case, an alarm event corresponding to the thus detected malfunction is generated in stage 513. In the negative case, an alarm event corresponding to the risk of malfunction which was detected in stage 511 is generated in stage 514.

The diagnostic module 9 makes it possible to prevent the malfunction of the read and/or write device 3 or a removable storage medium 4 by generating an alarm event in stages 502, 506, 510 and 514. This alarm event can take the form of a message, which can be communicated via the human/machine interface 25, for the attention of the user. This message can inform the user of the detected risk of malfunction. The message can also suggest to the user maintenance operations to be carried out on the use of this removable storage medium 4 or this read and/or write device 3, to prevent a malfunction of this removable storage medium 4 or this read and/or write device 3.

Similarly, the diagnostic module 9 makes it possible to detect a malfunction of a read and/or write device and to generate alarm events in stages 501, 505, 509 and 513. These alarm events can take the form of a message to the user via the human/machine interface 25, informing the user of the malfunction and proposing a maintenance operation to be carried out.

Alternatively or in combination, the diagnostic reports can be sent to a software application (not shown) which manages the archiving and backups on the peripherals 2 of the computer device 1. These diagnostic reports can take the form of a file which is communicated via transmission means to a computer (not shown) which includes this software application.

These transmission means can be the communication network 16, for example. The software application would then be kept informed of any risk of malfunction of each removable storage medium 4 and each read and/or write device 3. The software application could then carry out operations to migrate data which is recorded on a removable storage medium 4 which is failing or at risk of failing to another removable storage medium 4. The software application could then also limit the use of certain read and/or write devices 3 and certain removable storage media 4, or carry out maintenance operations on certain read and/or write devices 3, according to the received report files, to limit the loss or risk of loss of backed-up and archived data.

It should be noted that other means of communicating alarm events to the said software application may be used, such as sending commands which conform to an Application Programming Interface (API) of this software application.

In a second embodiment (shown in FIG. 2), the computer device 1 according to the invention includes multiple machines (computers). It includes one machine, called the monitoring machine 21, which is similar to the computer 24 of FIG. 1 and includes a processing module 7 and a diagnostic module 9. The computer device 1 includes other machines, called storage servers 20, 20a, 20b, which each include a CPU 5, which is similar to that of the computer 24 and connected to mass storage peripherals 2. The CPUs of the storage servers 20, 20a, 20b each include a monitoring module 6, which is loaded into RAM.

In the shown example, the peripherals 2 which are associated with a storage server 20a can be, as described for the single computer 24, connected directly to the CPU 5 of this storage server 20a via a peripheral bus 14 of SCSI type and a controller 12 of this peripheral bus 14.

The peripherals 2 which are associated with another storage server 20b can also be distributed on a network of Storage Area Network (SAN) type. Such a SAN can be of “Fiber Channel” type. Each peripheral 2 of this SAN can thus receive commands which the monitoring module 6 initiates.

In practice, a “Fiber Channel” switch 19 can connect the peripherals 2 to the storage server 20b. To do this, the CPU 5 is connected to the switch 19 via a “Fiber Channel” peripheral card 18. The peripherals 2 are connected to this “Fiber Channel” switch 19, and can also be of SCSI type and be adapted for each including a “Fiber Channel”/SCSI bus converter (not shown) so that they can communicate with the switch 19 and the storage server 20b.

The storage servers 20a, 20b can communicate with the monitoring machine 21 via a communication network 16 such as the Internet or a local network (e.g. Ethernet®). To do this, each storage server 20a, 20b and the monitoring machine 21 are equipped with a network card 17 which is adapted to communication on the network 16. Thus the LOGFILE files which the monitoring modules 6 of the storage servers 20, 20a, 20b generate can be sent to the monitoring machine 21 and be processed by its processing module 7.

Preferably, the diagnostic module 9 of the monitoring machine 21 also carries out a diagnosis of the read and/or write devices and the removable storage media 4 after each processing of a LOGFILE file by the processing module, as described above.

Architectures of the computer device 1 other than those given as non-limiting examples (FIGS. 1 and 2) are of course conceivable.

The network monitoring architecture of mass storage peripherals 2 according to the invention is particularly useful for monitoring a large quantity of removable storage media 4, for example at least a hundred removable storage media 4 which can be loaded onto at least ten read and/or write devices 3.

Alternatively, each monitoring module 6 can be a hardware module such as a peripheral card, which is connected to a peripheral bus 14 to which at least one monitored peripheral 2 is connected. This hardware monitoring module 6 would include means making it possible to send LOGFILE files which are collected for each monitored peripheral 2 to a processing module 7 via a communication network.

It should also be noted that several variants are possible for implementing the monitoring module 6. Additionally, the processing module 7 and/or the diagnostic module 9 can be implemented in the form of a hardware module such as a peripheral card. A hybrid software/hardware solution can be kept for each of the modules according to the invention. The processing module 7 and/or the monitoring module 6 and/or the diagnostic module 9 can be combined into a single module which carries out the functions of these separate modules.

1. A computer device comprising:
at least one mass storage peripheral comprising at least one read and/or write device, and adapted for receiving at least one removable storage device, this mass storage peripheral being adapted for generating data, called activity data, which represents its use and/or operation,
at least one software application which is adapted for carrying out read and/or write operations with the mass storage peripheral(s) in service,
at least one module for monitoring the quality of operation of at least one mass storage peripheral in service, called a monitored peripheral, this monitoring module being adapted for:
detecting, for each monitored peripheral, whether at least one read and/or write device receives a removable storage medium, this monitored peripheral being called an active monitored peripheral, or on the other hand whether it receives no removable storage medium, the monitored peripheral being called an inactive monitored peripheral,
collecting and recording over time, for each active monitored peripheral, activity data, called monitoring data, comprising data, which are called read and/or write quality data, adapted for making it possible to calculate quality parameters, the development of which over time is representative of a drift of the quality of read and/or write operations by each monitored peripheral,
being able to read, in at least one memory of the computer device, at least one identification data for each removable storage medium, called an identified removable medium, received in each monitored peripheral,
at least one processing module, which is adapted for:
calculating and recording, on the basis of the monitoring data, a history of quality parameters, called the activity history, of each read and/or write device of a monitored peripheral, this activity history being adapted for making it possible to prevent and/or detect a malfunction of each monitored peripheral,
also calculating and recording a history of quality parameters, called the activity history, of each identified removable storage medium, making it possible, with the activity history of each read and/or write device, to determine whether the origin of this malfunction is the removable storage medium and/or the read and/or write device.

2. A device as claimed in claim 1, wherein the activity history of each read and/or write device includes at least one quality parameter which is chosen from the read error rate and/or write error rate.

3. A device as claimed in claim 1, comprising multiple mass storage peripherals, and wherein the monitoring module(s) is(are) adapted for being able to collect and record monitoring data from multiple monitored peripherals.

4. A device as claimed in claim 1, wherein the activity history of each identified removable storage medium includes at least one quality parameter which is chosen from the read error rate and/or write error rate, and/or the number of loading and/or unloading operations, and/or the duration of use in a read and/or write device.

5. A device as claimed in claim 1, wherein the processing module is adapted for updating a single centralized database including the quality parameters of each read and/or write device of a monitored peripheral, and the quality parameters of each identified removable storage medium, this database forming the activity histories of each read and/or write device and each identified removable storage medium.

6. A device as claimed in claim 1, wherein the monitoring module(s) is/are adapted for collecting monitoring data periodically, according to a predetermined period.

7. A device as claimed in claim 6, wherein the period is between 1 s and 10 min, particularly of the order of 1 min.

8. A device as claimed in claim 1, wherein each monitoring module is adapted for being able to transmit the monitoring data to the processing module, and the processing module is adapted for calculating and recording each activity history immediately after receiving this monitoring data.

9. A device as claimed in claim 1, wherein each mass storage peripheral includes a local memory, called an activity register, and at least one controller which is adapted for being able to record the activity data in those areas of the activity register which are predetermined according to the nature of the activity data, and each monitoring module is adapted for reading those areas of the activity register which correspond to monitoring data.

10. A computer device comprising:
at least one mass storage peripheral comprising at least one read and/or write device, and adapted for receiving at least one removable storage device, this mass storage peripheral being adapted for generating data, called activity data, which represents its use and/or operation,
at least one software application which is adapted for carrying out read and/or write operations with the mass storage peripheral(s) in service,
at least one module for monitoring the quality of operation of at least one mass storage peripheral in service, called a monitored peripheral, this monitoring module being adapted for:
detecting, for each monitored peripheral, whether at least one read and/or write device receives a removable storage medium, this monitored peripheral being called an active monitored peripheral, or on the other hand whether it receives no removable storage medium, the monitored peripheral being called an inactive monitored peripheral,
collecting and recording over time, for each active monitored peripheral, the activity data, called monitoring data, comprising data called read and/or write quality data, which is adapted for making it possible to calculate the quality parameters, the development of which over time is representative of a drift of the quality of read and/or write operations by each monitored peripheral,
being able to read, in at least one memory of the computer device, at least one identification data for each removable storage medium, called an identified removable medium, which is received in each monitored peripheral,
at least one processing module, which is adapted for:
calculating and recording, on the basis of the monitoring data, a history of the quality parameters, called the activity history, of each read and/or write device of a monitored peripheral, this activity history being adapted for making it possible to prevent and/or detect a malfunction of each monitored peripheral,
also calculating and recording a history of quality parameters, called the activity history, of each identified removable storage medium, making it possible, with the activity history of each read and/or write device, to determine whether the origin of this malfunction is the removable storage medium and/or the read and/or write device,
at least one diagnostic module which is adapted for, from each activity history which it receives, triggering an alarm event when at least one quality parameter takes a value corresponding to a risk of possible malfunction of the identified removable storage medium (4) and/or of a read and/or write device.

11. A device as claimed in claim 10, wherein the processing module is adapted for calculating a value of at least one development parameter which represents the variation over time of a quality parameter, and wherein the diagnostic module is adapted for triggering an event alarm when at least one development parameter takes a value corresponding to a risk of possible malfunction of the identified removable storage medium and/or of a read and/or write device.

12. A device as claimed in claim 11, wherein the processing module is adapted for comparing each development parameter with a predetermined threshold value, and the diagnostic module is adapted for triggering an alarm event when this threshold value is exceeded.

13. A device as claimed in claim 10, wherein the diagnostic module is adapted for comparing each quality parameter with a predetermined threshold value, and triggering an alarm event when this threshold value is exceeded.

14. A device as claimed in claim 10, wherein the diagnostic module is adapted for being executed immediately after each recording of an activity history by the processing module.
